(19) United States
(12) Patent Application Publication
(10) Pub. No.: US 2007/0054706 A1
(43) Pub. Date: Mar. 8, 2007

(54) Wireless headset device having recharging battery

(76) Inventor: Serina Liu, Baldwin, CA (US)

Correspondence Address: LEONG C LEI, PMB # 1008, 1867 YGNACIO VALLEY ROAD, WALNUT CREEK, CA, 94598, US

(21) Appl. No.: 11/219,791

(22) Filed: Sep. 7, 2005

(51) Int. Cl. H04B 1/38

(52) U.S. Cl. 455/573

(57) ABSTRACT

A wireless headset device having a recharging battery is provided herein. The device mainly contains a wireless headset member and a charging member, with an appropriate electrical connection there between. While connected, the charging member constantly charges the wireless headset member. When a Bluetooth module inside the wireless headset member detects an incoming call, the charging member is notified of the event through the electrical connection. The charging member then drives its vibration module to alert the user even though the user does not carry the handset with him/her and has kept the wireless headset member in a pocket.

### BACKGROUND OF THE INVENTION

(a) Technical Field of the Invention

The present invention generally relates to wireless headsets for mobile handsets and, more particularly, to a wireless headset device having a recharging battery capable of generating vibration in the event of an incoming call.

(b) Description of the Prior Art

The unprecedented convenience of mobile communications has made the mobile handsets a necessity in people's daily life. With a handset in head, a person is always connected to the world “village.”

However the use of handsets still has a lot of room for improvement. For example, the electromagnetic wave produced by the handset is always a concern to some users, worrying that their health may be at stake. In addition, answering or making calls while driving has been one of the causes to traffic accidents. Due to these and other issues, more and more people use their handsets with a headset.

The trouble in managing the dangling cable of a wired headset has made the wireless headset the mainstream accessory for mobile handsets.

However, the wireless headset also still has some room for improvement. For example, a wireless headset usually obtains its power from an internal battery and the battery requires constant recharging. It is quite frustrating to many wireless headset users that their wireless headsets have run out of power during an important phone call.

In addition, if the user leaves the handset in a near-by area without carrying it and has set aside the headset in a pocket, the user may miss an incoming call especially when the handset is put into the silent mode and the vibration of the handset is usually the only clue to the user that there is an incoming call.

### SUMMARY OF THE INVENTION

The primary purpose of the present invention is to provide, a wireless headset device having a recharging battery is herein to mitigate the foregoing problems of a conventional wireless headset. The present invention mainly contains a wireless headset member and a charging member, with an appropriate electrical connection there between. When a Bluetooth module inside the wireless headset member detects an incoming call, the charging member is notified of the event through the electrical connection, and the vibration generated by the vibration module alerts the user. As such, if the user leaves the handset in a near-by area without carrying it and has kept the present invention in a pocket, the user can sense the vibration of the charging member and pick up the call. This is the major objective of the present invention.

In addition, the wireless headset member of the present invention contains an input/output module equipped with a buzzer, an indicator lamp, and/or a display. Therefore, beside the vibration provided by the charging member, the wireless headset member could also provide various other forms of notification for incoming calls, even when the wireless headset member is not connected to the charging member. This is another objective of the present invention.

Furthermore, the charging member could further contain a micro-controller and a caller-ID display. The wireless headset member to the micro-controller of the charging member first delivers the incoming call notification. The micro-controller then drives the vibration module and shows the caller ID of the incoming call on the display. As such, a user is able to learn who the caller is if the user has missed the call. This is yet another objective of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a first embodiment of the present invention.

FIG. 2 is a schematic diagram showing a second embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

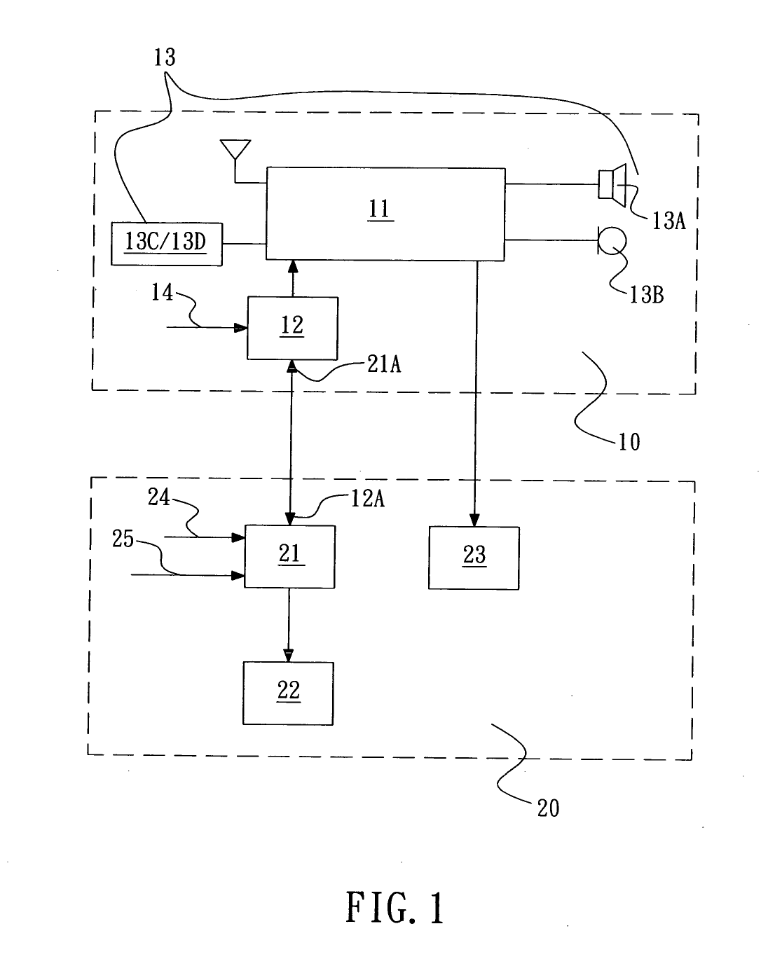

FIG. 1 is a schematic diagram showing a first embodiment of the present invention. As illustrated, the present invention mainly contains a wireless headset member 10 and a charging member 20, with an appropriate electrical connection there between. The connection is detachable which means that the wireless headset member 10 could be used alone without connecting to the charging member 20. Please note that the connection is detachable. If the electrical connection is detached, the wireless headset member is used just like an ordinary wireless headset. The connection could be implemented in various ways and should be common to people in the related arts. The wireless headset member 10 in turn contains a Bluetooth module 11, a power management module 12, and an input/output module 13. The charging member 20, on the other hand, contains at least a power control module 21, a charging status display module 22, and a vibration module 23. The power control module 21 receives the electrical power 24 from an internal rechargeable battery (not shown) of the charging member 20, the electrical power 25 from an external power adaptor (not shown), and the full-rating electrical power 12A from the power management module 12 of the wireless headset member 10. On the other hand, the power management module 12 receives the electrical power 14 from an internal rechargeable battery (not shown) of the wireless headset member 10, and the electrical power 21A from the power control module 21. In turn, the power management module 12 delivers power to drive the Bluetooth module 11. When the Bluetooth module 11 detects an incoming call, the Bluetooth module 11 alerts the user about the event through the input/output module 13. If the wireless headset member 10 is connected to the charging member 20, the Bluetooth module 11 drives the vibration module 23 to deliver vibrations.

The input/output module 13 could contain a buzzer 13A, an indicator lamp 13B, and a display 13C, in addition to a-control button 13D. The control button 13D allows a user to select a desired type of alert. As such, the wireless headset member 10 could produce ringing from the buzzer 13A, flash the indicator lamp 13B, and/or trigger the charging member 20 to vibrate. The display 13C is used for showing operation settings and the charging status of the wireless headset member 10. With the foregoing functions, a user could configure the present invention into a vibration mode and keep the wireless headset member 10 and the charging member 20 connected together in a pocket. The wireless headset member 10 would be continuously re-charged by the charging member 20 and the user thereby could be less worried about whether there is enough power for the wireless headset member 10 to operate. When an incoming call has arrived, the Bluetooth module 11 would detect such an event and cause the charging member 20 to vibrate. In this way, the user wouldn't miss the incoming call.

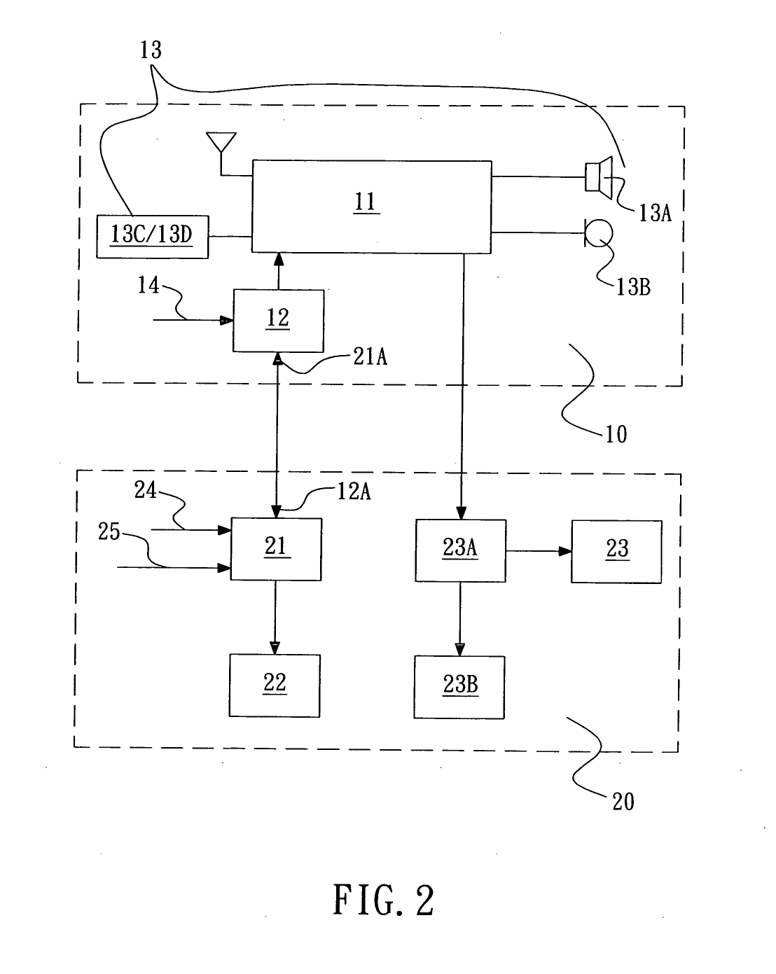

FIG. 2 is a schematic diagram showing a second embodiment of the present invention. As illustrated, the charging member 20 of the present embodiment has an additional micro-controller 23A and an additional caller-ID display 23B. When an incoming call arrives, in the present embodiment, the Bluetooth module 11 will first trigger the micro-controller 23A. The micro-controller 23A then directs electrical power to the vibration module 23 to generate vibrations, and shows the caller ID on the display 23B. If the user misses the call, later the user could learn who the caller is by reading the caller ID directly from the display 23B, instead of locating and checking the handset.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device, comprising:
a wireless headset member, said wireless headset member comprising a Bluetooth module, a power management module, and an input/output module;
a charging member, said charging member comprising a power control module, a charging status display module, and a vibration module; and
an appropriate detachable electrical connection between said wireless headset member and said charging member;
wherein said power control module receives the electrical power from an internal rechargeable battery of said charging member, the electrical power from an external power adaptor, and the full-rating electrical power from said power management module;
said power management module receives the electrical power from an internal rechargeable battery of said wireless headset member, and the electrical power from said power control module;
said power management module delivers power to drive said Bluetooth module;
when said Bluetooth module detects an incoming call, said Bluetooth module alerts a user about the event through said input/output module, and, if said wireless headset member is connected to said charging member, said Bluetooth module drives said vibration module to deliver vibrations.

2. A device, comprising:
a wireless headset member, said wireless headset member comprising a Bluetooth module, a power management module, and an input/output module;
a charging member, said charging member comprising a power control module, a charging status display module, a micro-controller, a caller-ID display, and a vibration module; and
an appropriate detachable electrical connection between said wireless headset member and said charging member;
wherein said power control module receives the electrical power from an internal rechargeable battery of said charging member, the electrical power from an external power adaptor, and the full-rating electrical power from said power management module;
said power management module receives the electrical power from an internal rechargeable battery of said wireless headset member, and
the electrical power from said power control module;
said power management module delivers power to drive said Bluetooth module;
when said Bluetooth module detects an incoming call, said Bluetooth module alerts a user about the event through said input/output module, and, if said wireless headset member is connected to said charging member, said Bluetooth module triggers said micro-controller, said micro-controller directs electrical power to said vibration module to deliver vibrations while showing the caller ID of said incoming call on said caller-ID display.

3. The device according to claim 1, wherein said input/output module of said wireless headset member comprises at least one of the following: a buzer, an indicator lamp, a display, and a control button.

4. The device according to claim 2, wherein said input/output module of said wireless headset member comprises at least one of the following: a buzzer, an indicator lamp, a display, and a control button.
